(19) United States
(12) Patent Application Publication
(10) Pub. No.: US 2024/0059843 A1
(43) Pub. Date: Feb. 22, 2024

(54) THERMAL GEL COMPOSITION

(71) Applicant: Momentive Performance Materials Inc., Waterford, NY (US)

(72) Inventors: Pranabesh DUTTA, Bangalore (IN); Debarshi DASGUPTA, Bangalore (IN); Anjitha MS, Wayanad (IN); Tetsuo FUJIMOTO, Gunma (JP); Chisato HOSHINO, Gunma (JP)

(21) Appl. No.: 18/278,437

(22) PCT Filed: Mar. 4, 2022
(86) PCT No.: PCT/US2022/018825

§ 371 Date: Aug. 23, 2023

(30) Foreign Application Priority Data
Mar. 4, 2021 (IN) 202111009146

(51) Int. Cl. C08G 77/20; C08K 3/22; C08J 3/075

(52) U.S. Cl. CPC C08G 77/20; C08K 3/22; C08J 3/075; C08K 2003/2227; C08K 2201/001; C08K 2201/003; C08K 2003/385

(57) ABSTRACT

A one-component thermal gel composition comprising a crosslinked silicone gel, a hydrolyzable siloxane, a thermal conductivity enhancing agent, and optionally one or more additives is described.

### FIELD OF INVENTION

This application claims priority to and the benefit of Indian Provisional Patent Application 202111009146 filed on Mar. 4, 2021, the disclosure of which is incorporated herein by reference in its entirety.

### FIELD OF INVENTION

The present invention relates to a one component thermal gel composition comprising a crosslinked silicone gel, a hydrolysable organopolysiloxane, a conductivity enhancing agent, and optionally one or more additive. In particular, the present invention provides a combination of pre-cured gel with lower cross-linked density , a hydrolysable organopolysiloxane and a conductivity enhancing agent enabling the composition to meet high thermal conductivity while maintaining the desired processability, dispensability, and high reliability performance including, for example, controlling vertical slippage, cracking, and delamination at different application gaps that are required for easy application and long term stability.

### BACKGROUND

The limiting factor for the high-end performance of most of the modern electronic devices are the ineffective dissipation to the external atmosphere of heat generated by the electronic components and circuitry present in these devices. The components, more specifically power semiconductors such as transistors and microprocessors, are even more prone to undergo malfunction or failure at high temperatures when they are densely packed on the integrated board and chips. Thermal interface materials (TIM) are generally used to bridge the interface between hot components and a chassis or heat sink assembly to increase the overall heat transfer from electronic systems. In electronic components, “Gap fillers” are commonly used as TIMs, and particularly in application areas where structural bonding is not required. Silicone gap fillers with softer material properties are often a preferable choice as they tend to reduce contact resistance and thermal impedance, which results in better heat management across the devices and boards. More importantly, the low modulus of silicone gap fillers also decreases the stress on the board assembly due to the large mismatch of the coefficient of thermal expansion (CTE) in microelectronic packages with die chips, heat sinks, heat spreaders, and substrates. However, decreasing the modulus of the gap fillers is often associated with increased creep behavior under compression as well as poor recovery upon removal of the stress. Historically, thermal grease interface materials with thermal conductivity ranging between 0.1 to 5 W/mK have been the first choice for filling up the interstitial space between different heat generating components and the heat sink because of their good compressibility with low application pressure, ability to fill interstices, low thermal resistance, and low cost. However, grease materials are vulnerable to pump-out and dry-out when exposed to thermal and power cycling conditions causing migration, contamination, and/or short-circuiting. Moreover, handling and application of grease materials has always posed challenges that limit the attractiveness of grease materials as thermal packaging materials.

As an alternative to grease, liquid dispensable gap fillers have gained a lot of interest in recent times to fill the large and uneven gaps in assemblies. Most of the liquid dispensable gap fillers available in the market today are two-component, room or elevated temperature curing systems that result in a soft, thermally conductive, form-in-place elastomer, which is ideal for coupling “hot” electronic components on PC boards with an adjacent metal case or heat sink. These gap fillers are made thixotropic to varying degrees, so they will retain their shape after mixing and dispensing till cure. They have a relatively high at-rest viscosity. However, when a shear force is applied, such as during the dispensing process, the viscosity decreases, allowing for easy dispensing. They also have a natural tackiness when cured that permits mild adhesion to adjacent components. This helps to retain the material at the application space and eliminates pump-out during repeated temperature cycling.

Though the two-part dispensable gap fillers are employed widely in electronic applications as thermal management materials, they tend to have a limited shelf life and require curing after application, which can lead to hardening, cracking and device failure.

U.S. Pat. No. 5,348,686 describes a formulated gel characterized by non-flowing, self-healing, thermally stable properties with improved electrical conductivity, where the conductive gel is a crossed-linked polysiloxane polymer prepared using a vinyl terminated poly-dimethyl siloxane with a very flexible cross-linker in the presence of silver flakes and silver coated mica. U.S. Pat. No. 8,119,191 relates to a process of using a fully cured dispensable polymer gel component admixed with a thermally and electrically conductive component in an amount of 20-80% by total weight of the compound to exhibit a thermal conductivity of at least about 0.5 W/m-K or 0.7 W/m-k, for facilitating electromagnetic/radiofrequency interference (EMI/RFI) shielding and thermal management in packaging circuits. U.S. Pat. No. 10,428,256 describes a two-component releasable thermal gel composition that is mixed before the point of application and facilitates catalytic cross-linking. The thermal gel in the '256 patent includes a first component including a primary silicone oil, an inhibitor, a catalyst, and at least one conductivity enhancing agent, and a second component including a primary silicone oil, a cross linking silicone oil, and at least one conductivity enhancing agent, wherein the ratio of total content of Si—H groups to total content of vinyl groups in the thermal gel is between 0.03 to 10. Such materials are further described in commonly assigned U.S. Pat. No. 8,187,490 entitled “Heat dissipating material and semiconductor device using same” and are marketed commercially under the names SIL-COOL Gel® TIG300BX, TIG400BX, TIG2000BX by Momentive Performance Materials Inc. Thermal gel or gel-like materials may also be described in U.S. Pat. Nos. US 9,260,645; 5,679,457; 5,545,473; 5,533,256; 5,510,174; 5,471,027; 5,359,768; 5,321,582; 5,309,320; 5,298,791; 5,213,868; 5,194,480; 5,151,777; 5,137,959; 5,060,114; 4,979,074; 4,974,119; 4,965,699; 4,869,954; 4,842,911; 4,782,893; 4,685,987; 4,654,754; 4,606,962; 4,602,678, and in WO 96/37915. Still other gel-like materials are described in U.S. Pat. Nos. 6,031,025; 5,929,138; 5,741,877; 5,665,809; 5,467,251; 5,079,300; 4,852,646; in WO 96/05602, and WO 00/63968; and EP 643,551.

These proposed solutions, however, do not address the need for a thermal conductive composition that possess a combination of desired attributes, namely, high thermal conductivity, processability, dispensibility, and reliability.

### SUMMARY

The following presents a summary of this disclosure to provide a basic understanding of some aspects of the invention. This summary is intended to neither identify key or critical elements nor define any limitations of embodiments or claims. Furthermore, this summary may provide a simplified overview of some aspects that may be described in greater detail in other portions of this disclosure.

In one aspect, provided is a one-component thermal-gel composition comprising:

(A) a cross linkable organopolysiloxane prepared by reaction of:
(i) an alkenyl-functionalized diorganopolysiloxane of formula (Ia)

M¹ₐM²_{b}D¹_{c}D²_{d}T¹ₑT²_{f}Q_{g} (Ia)
wherein
M¹=R¹R²R³SiO_{1/2}
M²=R⁴R⁵R⁶SiO_{1/2}
D¹=R⁷R⁸SiO_{2/2}
D²=R⁹R¹⁰SiO_{2/2}
T¹=R¹¹SiO_{3/2}
T²=R¹²SiO_{3/2}
Q=SiO_{4/2}
where R², R³, R⁴, R⁵, R⁶, R⁸, R⁹, R¹⁰, R¹² are each independently selected from an aliphatic, aromatic, or fluoro monovalent hydrocarbon having from 1 to 60 carbon atoms or alkoxy groups;
R¹, R⁷, R¹¹ are monovalent radical containing at least one terminal olefin bond; and
the subscripts a, b, c, d, e, f, and g are zero or a positive integer subject to the following limitations: 1≤a+b+c+d+e+f+g≤6000, and a+c+e≥1; with
(ii) a hydrogen-functionalized organopolysiloxane of formula (Ib)

M¹_{a′}M²_{b′}D¹_{c′}D²_{d′}T¹_{e′}T²_{f′}Q_{g′} (1b)
wherein:
M¹=R¹³R¹⁴R¹⁵SiO_{1/2}
M²=R¹⁶R¹⁷R¹⁸SiO_{1/2}
D¹=R¹⁹R²⁰SiO_{2/2}
D²=R²¹R²²SiO_{2/2}
T¹=R²³SiO_{3/2}
T²=R²⁴SiO_{3/2}
Q=SiO_{4/2}
where R¹⁴, R¹⁵, R¹⁶, R¹⁷, R¹⁸, R²⁰, R²¹, R²², R²⁴ are aliphatic, aromatic or fluoro monovalent hydrocarbon having from 1 to 60 carbon atoms;
R¹³, R¹⁹, R²³ are hydrogen;
the subscript a′, b′, c′, d′, e′, f′, and g′ are zero or a positive integer subject to the following limitations: 1≤a′+b′±c′+d′+e′+f+g′≤6000, and a′+c′+e′≥1;
   with the proviso that when a′+c′+e′=1 then a+c+e>1 and when a+c+e=1 then a′+c′+e′>1;
   (B) a hydrolyzable organopolysiloxane selected from a compound of formula (II), formula (III), or a combination therefore, where formula (II) is of the formula:

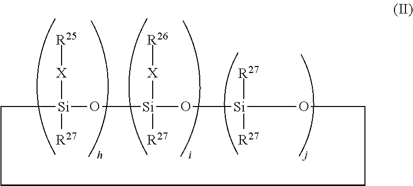

wherein
R²⁵ is a group having an alkoxysilyl group having 1 to 4 carbon atoms;
R²⁶ is a linear organosiloxy group (III):

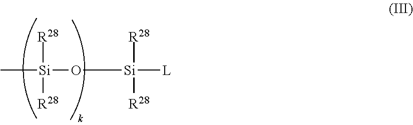

wherein each R²⁸ is independently a monovalent hydrocarbon group having 1 to 12 carbon atoms; L is selected from a monovalent hydrocarbon group having 1 to 6 carbon atoms, and an alkoxysilyl group having 1 to 4 carbon atoms; and k is an integer from 10 to 500;
each X is independently a divalent hydrocarbon group having 2 to 10 carbon atoms;
each of h and i is independently an integer of 1 or more;
j is an integer of 0 or more;
h+i+j is an integer of 4 or more; and
each R²⁷ is independently selected from hydrogen and a monovalent hydrocarbon group having 1 to 6 carbon atoms; and
formula (IV) is:

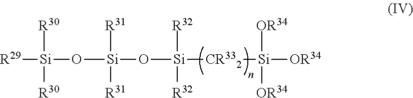

where wherein, R²⁹ represents an unsubstituted or substituted alkyl group, alkenyl group or aryl group, each R³⁰ represents, independently, an unsubstituted or substituted alkyl group, alkenyl group or aryl group, R³¹ and R³² each represent identical or different unsubstituted or substituted monovalent hydrocarbon groups, each R³³ represents, independently, a hydrogen atom, or an unsubstituted or substituted monovalent hydrocarbon group, each R³⁴ represents, independently, an unsubstituted or substituted alkyl group, alkoxyalkyl group, alkenyl group or acyl group, m represents an integer from 0 to 4, and n represents an integer from 2 to 20;
(C) a thermal conductivity enhancing agent;
(D) optionally an organopolysiloxane having an average of at least one silicone bonded alkenyl group per molecule;
(E) optionally an adhesion promoter;
(F) optionally an antioxidant; and
(G) optionally a pigment.

In one embodiment, the hydrolyzable organopolysiloxane (B) is selected from a compound of formula (II).

In one embodiment, k is 10 to 50.

In one embodiment, the hydrolyzable organopolysiloxane (B) comprises two or more hydrolyzable organopolysiloxane compunds of the formula (II).

In one embodiment, the hydrolyzable organopolysiloxane (B) comprises a first hydrolyzable organopolysiloxane of the formula (II) where k is 10 to 50, and a second hydrolyzable organopolysiloxane of the formula (II) where k is 100 to 500.

In one embodiment in accordance with any previous embodiment, the cross-linkable organopolysiloxane (A) is present in an amount of from about 0.2 wt. % to about 10 wt. % based on the total weight of the composition.

In one embodiment, the first hydrolyzable orgaonopolysiloxane is present in an amount of from about 0.2 wt. % to about 10 wt. % based on the total weight of the composition, and the second hydrolyzable organopolysiloxane is present in an amount of from about 0.2 wt. % to about 10 wt. % based on the total weight of the composition.

In one embodiment in accordance with any previous embodiment, the cross-linkable organopolysiloxane (A) is present in an amount of from about 0.2 wt. % to about 10 wt. % based on the total weight of the composition.

In one embodiment in accordance with any previous embodiment, the thermal conductivity enhancing agent is selected from a metal oxide, a metal nitride, a metal carbide, a metal, a metal alloy, a carbon based filler, or a combination of two or more thereof

In one embodiment, the thermal conductivity enhancing agent is selected from diamond, graphite, graphene, carbon nanotubes, boron nitride, aluminum nitride, silicon nitride, titanium nitride, zirconium nitride, aluminum oxide, zinc oxide, zirconium oxide, cerium oxide, magnesium oxide, or a mixture of two or more thereof

In one embodiment in accordance with any previous embodiment, the thermal conductivity enhancing agent is present in an amount of from about 80 wt. % to about 97 wt. % based on the total weight of the composition.

In one embodiment, the thermal conductivity enhancing agent is selected from a first aluminum oxide of a first particle size, a second aluminum oxide of a second particle size, and a third aluminum oxide of a third particle size.

In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

In one embodiment, the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

In one embodiment, the thermal conductivity enhancing agent comprises aluminum oxide and boron nitride.

In one embodiment, the aluminum oxide is present in an amount of from about 50 wt. % to about 95 wt. % based on the total weight of the composition, and the boron nitride is present in an amount of from about 2 wt. % to about 30 wt. % based on the total weight of the composition.

In one embodiment, the aluminum oxide comprises a first aluminum oxide of a first particle size, a second aluminum oxide of a second particle size, and a third aluminum oxide of a third particle size.

In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

In one embodiment, the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

In one embodiment, the thermal conductivity enhancing agent comprises aluminum oxide, boron nitride, and aluminum nitride.

In one embodiment, the aluminum oxide is present in an amount of from about 50 wt. % to about 95 wt. % based on the total weight of the composition, the boron nitride is present in an amount of from about 2 wt. % to about 30 wt. % based on the total weight of the composition, and the aluminum nitride is present in an amount of from about 30 wt. % to about 95 wt. % based on the total weight of the composition.

In one embodiment, the aluminum oxide comprises a first aluminum oxide of a first particle size, a second aluminum oxide of a second particle size, and a third aluminum oxide of a third particle size.

In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

In one embodiment, the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

In one embodiment, the thermal conductivity enhancing agent is comprises zinc oxide, aluminum oxide, and aluminum nitride.

In one embodiment, the aluminum oxide comprises a first aluminum oxide of a first average particle size and a second aluminum oxide of a second average particle size, and the aluminum nitride comprises a first aluminum nitride of a first average particle size and a second aluminum nitride of a second average particle size.

In one embodiment, the first aluminum oxide has an average particle size from about 0.01 to about 0.5 μm; the second aluminum oxide has an average particle size of about 1 μm to about 25 μm; wherein the first aluminum nitride has an average particle size from about 1 μm to about 25 μm; and the second aluminum nitride has an average particle size of about 40 μm to about 150 μm.

In another aspect, provided is a device comprising a first substrate, a second substrate, and an interface material bridging an interface between the first and second substrate, wherein the thermal interface material comprises the one-component thermal-gel composition of any of the previous embodiments.

In another aspect, the present invention provides a heat dissipating material comprising the thermal gel composition of the invention.

In another aspect, the present invention provides a method of dissipating heat from a substrate, the method comprising contacting the substrate with the thermal gel composition of the invention.

In yet another aspect, the present invention provides a method of preparing a treated substrate comprising applying the thermal gel composition of the invention to a surface of a substrate.

In a further aspect, the present invention provides a device comprising a treated substrate wherein the treated substrate comprises the thermal gel composition of the present invention. The following description and the drawings disclose various illustrative aspects. Some improvements and novel aspects may be expressly identified, while others may be apparent from the description and drawings.

### BRIEF DESCRIPTION OF THE DRAWINGS

FIG. 1 shows vertical stability performance under thermal shock after 500 h (0.5 mm, 1 mm and 2 mm gap, bottom to top) under thermal shock (−40 C to 150° C.) for examples CE-1, and CE-5, CE-6, CE-7, CE-8, and CE-9;

FIG. 2 shows vertical stability performance under thermal shock after 500 h (0.5 mm, 1 mm and 2 mm gap, bottom to top) under thermal shock (−40 C to 150° C.) for examples 1-5;

FIG. 3 shows Bleed out performance on different substrate for example 8; and

FIG. 4 shows Bleed out performance on smoke glass at different temperature for example 4.

### DETAILED DESCRIPTION

Reference will now be made to exemplary embodiments, examples of which are illustrated in the accompanying drawings. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As used herein, the term “thermal conductivity enhancing agent” means a solid compound or a mixture of compounds that enhances the thermal conductivity of a composition. Examples of conductivity enhancing agents include, but are not limited to, solid inorganic compounds such as boron nitride, aluminum nitride, aluminum oxide, zinc oxide, aluminium metal, graphite, diamond, silicon carbide, aluminum metal or a mixture thereof.

As used herein, the term “pre-cured gel” means a fluid-extended polymer system which may include a continuous polymeric phase or network, which may be chemically, e.g., ionically or covalently, or physically cross-linked, and an oil, such as a silicone or other oil, a plasticizer, unreacted monomer, or other fluid extender which swells or otherwise fills the interstices of the network. The cross-linking density of such network and the proportion of the extender can be controlled to tailor the modulus, i.e., softness, and other properties of the gel. The term “pre-cured gel” also should be understood to encompass materials which alternatively may be classified broadly as pseudogels or gel-like as having viscoelastic properties similar to gels, such has by having a “loose” cross-linking network formed by relatively long cross-link chains, but as, for example, lacking a fluid-extender

The expression “monovalent hydrocarbon” means any hydrocarbon group from which one or more hydrogen atoms has been removed and is inclusive of alkyl, alkenyl, alkynyl, cyclic alkyl, cyclic alkenyl, cyclic alkynyl, aryl, aralkyl and arenyl and may contain heteroatoms.

The term “alkyl” means any monovalent, saturated straight, branched or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

The expressions “cyclic alkyl”, “cyclic alkenyl”, and “cyclic alkynyl” include bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “arenyl” means any aryl group (as defined herein) in which one or more hydrogen atoms have been substituted by the same number of like and/or different alkyl groups (as defined herein). Examples of aryls include phenyl and naphthalenyl. Examples of aralkyls include benzyl and phenethyl. Examples of arenyls include tolyl and xylyl.

The disclosure may identify a number of different ranges for a component or components in the composition. It will be appreciated that the numerical values of the respective ranges can be combined to form new and non-specified ranges.

In one aspect, the present invention provides a composition comprising:

(A) Cross linkable organopolysiloxane prepared by reaction of:
(i) an alkenyl-functionalized diorganopolysiloxane of formula (Ia)

M¹ₐM²_{b}D¹_{c}D²_{d}T¹ₑT²_{f}Q_{g} (Ia)
wherein
M¹=R¹R²R³SiO_{1/2}
M²=R⁴R⁵R⁶SiO_{1/2}
D¹=R⁷R⁸SiO_{2/2}
D²=R⁹R¹⁰SiO_{2/2}
T¹=R¹¹SiO_{3/2}
T²=R¹²SiO_{3/2}
Q=SiO_{4/2}
where R², R³, R⁴, R⁵, R⁶, R⁸, R⁹, R¹⁰, R¹² are each independently selected from an aliphatic, aromatic, or fluoro monovalent hydrocarbon having from 1 to 60 carbon atoms;
R¹, R⁷, R¹¹ are monovalent radical containing at least one terminal olefin bond; and
the subscripts a, b, c, d, e, f, and g are zero or a positive integer subject to the following limitations: 1≤a+b+c+d+e+f+g≤6000, and a+c+e>1;
with
   (ii) a hydrogen-functionalized organopolysiloxane of formula (Ib)

M¹_{a′}M²_{b′}D¹_{c′}D²_{d′}T¹_{e′}T²_{f′}Q_{g′} (Ib)
wherein:
M¹=R¹³R¹⁴R¹⁵SiO_{1/2}
M²=R¹⁶R¹⁷R¹⁸SiO_{1/2}
D¹=R¹⁹R²⁰SiO_{2/2}
D²=R²¹R²²SiO_{2/2}
T¹=R²³SiO_{3/2}
T²=R²⁴SiO_{3/2}
Q=SiO_{4/2}
where R¹⁴, R¹⁵, R¹⁶, R¹⁷, R¹⁸, R²⁰, R²¹, R²²,
R²⁴ are aliphatic, aromatic or fluoro monovalent hydrocarbon having from 1 to 60 carbon atoms;
R¹³, R¹⁹, R²³ are hydrogen;
the subscript a′, b′, c′, d′, e′, f′, and g′ are zero or a positive integer subject to the following limitations: 1<a′+b′+c′+d′+e′+f+g′≤6000, and a′+c′+e′≥1;
   with the proviso that when a′+c′+e′=1 then a+c+e>1 and when a+c+e=1 then a′+c′+e′>1;
(B) at least one hydrolyzable organopolysiloxane selected from a compound of formula (II), formula (IV), or a combination thereof:

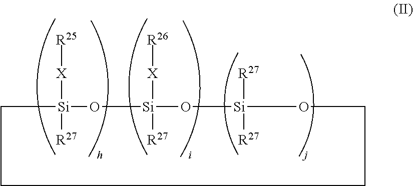

wherein
R²⁵ is a group having an alkoxysilyl group having 1 to 4 carbon atoms;
R²⁶ is a linear organosiloxy group represented by the following general formula (III):

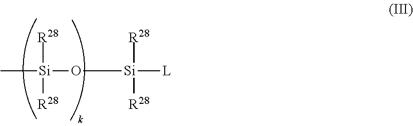

wherein each R²⁸ is independently a monovalent hydrocarbon group having 1 to 12 carbon atoms; L is selected from a monovalent hydrocarbon group having 1 to 6 carbon atoms, and an alkoxysilyl group having 1 to 4 carbon atoms; and
k is an integer from 10 to 500, 25 to 400, 50 to 300, 75 to 250, or 100 to 150;
each X is independently a divalent hydrocarbon group having 2 to 10 carbon atoms;
each of h and i is independently an integer of 1 or more;
j is an integer of 0 or more;
h+i+j is an integer of 4 or more, and in embodiments 4 to 10; and
each R²⁷ is independently selected from hydrogen and a monovalent hydrocarbon group having 1 to 6 carbon atoms; and
formula (IV) is:

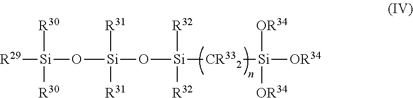

where wherein, R²⁹ represents an unsubstituted or substituted C1-C60 hydrocarbon group such as, but not limited to, an alkyl group, alkenyl group, or aryl group, each R³⁰ represents, independently, an unsubstituted or substituted C1-C60 hydrocarbon group such as, but not limited to, an alkyl group, alkenyl group, or aryl group, R³¹ and R³² each represent identical or different unsubstituted or substituted monovalent C1-C60 hydrocarbon groups, each R³³ represents, independently, a hydrogen atom, or an unsubstituted or substituted monovalent C1-C60 hydrocarbon group, each R³⁴ represents, independently, an unsubstituted or substituted C1-C60 alkyl group, an alkoxyalkyl group, a C2-C60 alkenyl group or acyl group, m represents an integer from 0 to 4, and n represents an integer from 2 to 20
(C) a thermal conductivity enhancing agent;
(D) optionally an organopolysiloxane having an average of at least one silicone bonded alkenyl group per molecule;
(E) optionally an adhesion promoter;
(F) optionally an antioxidant; and
(G) optionally a pigment.

In one embodiment, the hydrolyzable organopolysiloxane (B) comprises a compound of the formula (II). In one embodiment, the hydrolyzable organopolysiloxane (B) comprises a mixture of two or more materials of formula (II). In one embodiment, the hydrolyzable organopolysiloxane (B) is a compound of the formula (II) where h+i+j is 4-12, 4-10, 4-8, or 4-6, and k is 10-50, 15-40, 20-35, or 25-30. In one embodiment, the hydrolyzable organopolysiloxane (B) is a compound of the formula (II) where h+i+j is 4-12, 4-10, 4-8, or 4-6, and k is 100-500, 150-400, 200-300, or 250-350.

Example of suitable hydrocarbon groups for R², R³, R⁴, R⁵, R⁶, R⁸, R⁹, R¹⁰, R¹², R¹⁴, R¹⁵, R¹⁶, R¹⁷, R¹⁸, R²⁰, R²¹, R²², R²⁴ include, but are not limted to, monovalent C1-C60 alkyl radicals, monovalent C6-C30 aromatic radicals, and monovalent C1-C60 alkyl radicals where one or more of the hydrogen atoms attached to the carbon are replaced by a fluorine atom. Examplary hydrocarbon groups for R², R³, R⁴, R⁵, R⁶, R⁸, R⁹, R¹⁰, R¹², R¹⁴, R¹⁵, R¹⁶, R¹⁷, R¹⁸, R²⁰, R²¹, R²², R²⁴ include, but are not limited to, methyl, ethyl, n-propyl, iso-propyl, n-butyl, isobutyl, tert-butyl, n-pentyl, iso-pentyl, neopentyl and tert-pentyl; hexyl, such as the n-hexyl group; heptyl, such as the n-heptyl group; octyl, such as the n-octyl and isooctyl groups and the 2,2,4-trimethylpentyl group; nonyl, such as the n-nonyl group; decyl, such as the n-decyl group; cycloalkyl radicals, such as cyclopentyl, cyclohexyl and cycloheptyl radicals and methylcyclohexyl radicals Examples of aryl groups include phenyl, naphthyl; o-, m- and p-tolyl, xylyl, ethylphenyl, and benzyl.

Example of suitable hydrocarbon groups for R²⁹, R³⁹, R³¹, R³², and R³³ include, but are not limted to, monovalent C1-C60 alkyl radicals, monovalent C2-C60 alkenyl radicals, and monovalent C6-C30 aromatic radicals. Examples include, but are not limited to, methyl, ethyl, n-propyl, iso-propyl, n-butyl, isobutyl, tert-butyl, n-pentyl, iso-pentyl, neopentyl and tert-pentyl; hexyl, such as the n-hexyl group; heptyl, such as the n-heptyl group; octyl, such as the n-octyl and isooctyl groups and the 2,2,4-trimethylpentyl group; nonyl, such as the n-nonyl group; decyl, such as the n-decyl group; cycloalkyl radicals, such as cyclopentyl, cyclohexyl and cycloheptyl radicals and methylcyclohexyl radicals. Non-limiting examples of suitable alkenyl groups include vinyl, allyl, etc. Examples of aryl groups include phenyl, naphthyl; o-, m- and p-tolyl, xylyl, ethylphenyl, and benzyl.

In one embodiment, L in the group of Formula (III) is selected from a monovalent hydrocarbon group having 1 to 6 carbon atoms, and an alkoxysilyl group having 1 to 4 carbon atoms. In one embodiment, L is a C1-C6 alkyl group. In one embodiment, L is a C2-C6 alkynyl group. In one embodiment, L is a vinyl group.

The cross-linkable organopolysiloxane (A) can be present in an amount of from about 0.2 wt. % to about 10 wt. %, from about 0.5 wt. % to about 8 wt. %, or from about 1 wt. % to about 7 wt. % based on the total weight of the composition.

The hydrolyzable organopolysiloxane (B) can be present in an amount of from about 0.2 wt. % to about 10 wt. %, from about 0.5 wt. % to about 8 wt. %, or from about 1 wt. % to about 7 wt. % based on the total weight of the composition. The thermal conductivity enhancing agent comprises at least one compound that has the effect of enhancing the thermal conductivity of a composition. In one embodiment, the thermal conductivity enhancing agent comprises a compound selected from a metal oxide, a metal nitride, metal carbide, a metal, a metal alloy, carbon based fillers like diamond, graphite, graphene, carbon nanotubes or a combination of two or more thereof. In one embodiment, the thermal conductivity enhancing agent is selected from boron nitride, aluminum nitride, silicon nitride, titanium nitride, zirconium nitride, aluminum oxide, zinc oxide, zirconium oxide, cerium oxide, magnesium oxide, or a mixture of two or more thereof. Examples of suitable metals and metal alloys include, but are not limited to, silver, aluminum, gold, tungsten, gallium, bismuth, nickel, copper, SnBi, SnBiIn, CuSn, SnIn, SnBiAg, indium-gallium alloy, a gallium-tin-zinc alloy, an indium-gallium-tin alloy, an indium-gallium-bismuth-tin alloy, or an indium-bismuth-tin-silver alloy, iron-nickel alloys, silicon iron (FeSi), FeSiCr alloys, FeSiAl alloys, FeCO alloys, silver coated nickel, silver coated iron, silver coated cobalt, silver coated iron-nickel alloys, silver coated permalloy, silver coated ferrites, silver coated silicone iron, silver coated FeSiCr alloys, silver coated FeSiAl alloys, silver coated FeCO alloys and mixtures of two or more thereof

It will be appreciated that the conductivity enhancing agent may comprise a mixture of a single type of compound (e.g., aluminum oxide) where the mixture includes compounds of different average particle size. In one embodiment, the conductivity enhancing agent comprises aluminum nitride, boron nitride, and aluminum oxide.

The particle size of the conductivity enhancing agent may be chosen as desired for a particular purpose or intended application. In embodiments, the conductivity enhancing agent has an average particle size of from about 0.01 μm to about 500 μm; from about 0.1 to about 250 μm; from about 1 to about 100 μm; from about 5 to about 75 μm; even from about 10 to about 50 μm. It will be appreciated that the composition may comprise a combination of conductivity enhancing agents of different average particle sizes. Such combinations may be chosen as desired for a particular purpose or intended application. In one embodiment, the composition comprises a first conductivity enhancing agent having an average particle size from about 0.01 to about 0.1 μm; a second conductivity enhancing agent having an average particle size of about 1 μm to about 25 μm; and optionally a third conductivity enhancing agent having an average particle size of about 50 μm to about 100 μm. The first, second, and third conductivity enhancing agents may be the same or different from one another in terms of the chemical makeup of the filler. Particle size can be determined by any suitable method. Average particle size is often provided or reported from the supplier of the material. In one embodiment, average particle size can be determined using scanning electron microscopy (SEM).

The filler(s) may be present in an amount of from about 80 wt. % to about 97 wt. %, from about 82 wt. % to about 96 wt. %, or from about 85 wt. % to about 95 wt. % based on the total weight of the composition.

In one embodiment, the thermal conductivity enhancing agent comprises a first aluminum oxide having a first particle size, a second aluminum oxide having a second particle size, and a third aluminum oxide having a third particle size. In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm. The first, second, and third aluminum oxides may be the same or different from one another in terms of the chemical makeup of the filler. The first aluminum oxide may be present in an amount of from about 10 wt. % to about 40 wt. %, from about 15 wt. % to about 38 wt. %, or from about 18 wt. % to about 35 wt. % based on the total weight of the composition; the second aluminum oxide may be present in an amount of from about 5 wt. % to about 30 wt. %, from about 10 wt. % to about 28 wt. %, or from about 13 wt. % to about 25 wt. % based on the total weight of the composition; and optionally the third aluminum oxide may be present in an amount of from about 30 wt. % to about 70 wt. %, from about 33 wt. % to about 60 wt. %, or from about 35 wt. % to about 55 wt. % based on the total weight of the composition.

In one embodiment, the conductivity enhancing agent comprises boron nitride and aluminum oxide. In one embodiment, the aluminum oxide comprises a first aluminum oxide having a first particle size and a second aluminum oxide having a second particle size. In one embodiment, the aluminum oxide comprises a first aluminum oxide having a first particle size, a second aluminum oxide having a second particle size, and a third aluminum oxide having a third particle size. In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm. The first, second, and third aluminum oxides may be the same or different from one another in terms of the chemical makeup of the filler. The boron nitride may be present in an amount of from about 2 wt. % to about 30 wt. %, from about 3 wt. % to about 28 wt. %, or from about 5 wt. % to about 25 wt. % based on the total weight of the composition. The first aluminum oxide may be present in an amount of from about 10 wt. % to about 40 wt. %, from about 15 wt. % to about 38 wt. %, or from about 18 wt. % to about 35 wt. % based on the total weight of the composition; the second aluminum oxide may be present in an amount of from about 5 wt. % to about 30 wt. %, from about 10 wt. % to about 28 wt. %, or from about 13 wt. % to about 25 wt. % based on the total weight of the composition; and optionally the third aluminum oxide may be present in an amount of from about 30 wt. % to about 70 wt. %, from about 33 wt. % to about 60 wt. %, or from about 35 wt. % to about 55 wt. % based on the total weight of the composition.

In one embodiment, the thermal conductivity enhancing agent comprises aluminum oxide and boron nitride, where the aluminum oxide is present in an amount of from about 2 wt. % to about 75 wt. %, from about 15 wt. % to about 65 wt. %, or from about 10 wt. % to about 60 wt. %, and the boron nitride is present in an amount of from about 2 wt. % to about 30 wt. %, from about 3 wt. % to about 28 wt. %, or from about 5 wt. % to about 25 wt. % based on the total weight of the thermal conductivity enhancing agent. In one embodiment, the aluminum oxide comprises two or more types of aluminum oxide that differ from one another in terms of particle size.

In one embodiment, the thermal conductivity enhancing agent comprises aluminum oxide, boron nitride, and aluminum nitride, where the aluminum oxide is present in an amount of from about 50 wt. % to about 95 wt. %, from about 60 wt. % to about 90 wt. %, or from about 70 wt. % to about 85 wt. %; the boron nitride is present in an amount of from about 2 wt. % to about 30 wt. %, from about 3 wt. % to about 28 wt. %, or from about 5 wt. % to about 25 wt. %; and the aluminum nitride is present in an amount of from about 30 wt. % to about 95 wt. %, from about 35 wt. % to about 90 wt. %, or from about 45 wt. % to about 85 wt. %. In one embodiment, the aluminum oxide comprises two or more types of aluminum oxide that differ from one another in terms of particle size. In one embodiment, the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm. The first, second, and third aluminum oxides may be the same or different from one another in terms of the chemical makeup of the filler. The first aluminum oxide may be present in an amount of from about 10 wt. % to about 40 wt. %, from about 15 wt. % to about 38 wt. %, or from about 18 wt. % to about 35 wt. % based on the total weight of the composition; the second aluminum oxide may be present in an amount of from about 5 wt. % to about 30 wt. %, from about 10 wt. % to about 28 wt. %, or from about 13 wt. % to about 25 wt. % based on the total weight of the composition; and optionally the third aluminum oxide may be present in an amount of from about 30 wt. % to about 70 wt. %, from about 33 wt. % to about 60 wt. %, or from about 35 wt. % to about 55 wt. % based on the total weight of the composition.

In one embodiment, the thermal conductivity enhancing agent comprises zinc oxide, aluminum oxide, and aluminum nitride. In one embodiment, the zinc oxide is present in an amount of from about 0.1 wt. % to about 30 wt. %, from about 2 wt. % to about 20 wt. %, or from about 4 wt. % to about 15 wt. %; the aluminum oxide is present in an amount of from about 50 wt. % to about 95 wt. %, from about 60 wt. % to about 90 wt. %, or from about 70 wt. % to about 85 wt. %; and the aluminum nitride is present in an amount of from about 30 wt. % to about 95 wt. %, from about 35 wt. % to about 90 wt. %, or from about 45 wt. % to about 85 wt. %. In one embodiment, the aluminum oxide comprises a first aluminum oxide of a first average particle size and a second aluminum oxide of a second average particle size, and the aluminum nitride comprises a first aluminum nitride of a first average particle size and a second aluminum nitride of a second average particle size. In one embodiment, the first aluminum oxide has an average particle size from about 0.01 to about 0.5 μm; the second aluminum oxide has an average particle size of about 1 μm to about 25 μm; wherein the first aluminum nitride has an average particle size from about 1 μm to about 25 μm; and the second aluminum nitride has an average particle size of about 40 μm to about 150 μm.

The cross-linkable organopolysiloxane (A) may also be referred to herein as a pre-cured gel or a polymer gel. The cross-linkable organopolysiloxane (A) is made by reacting the alkenyl-functionalized diorganopolysiloxane (i) with hydrogen-functionalized organopolysiloxane (ii). The reaction may be conducted via hydrosilylation reaction conditions using an appropriate catalyst. A conventional hydrosilylation catalyst are platinum-based catalysts (such as, but not limited to, Karstedt's catalyst). In one embodiment, the pre-cured gel can be made by reacting a linear vinyl capped polysiloxanes with pendent poly(hydrosiloxane) or poly(methylhydrosiloxane) copolymers (cross-linker) or a crosslinked MT or MQ resin containing Si—H reactive groups through Pt catalyzed hydrosilylation reaction. A similar gel network can also be achieved by reacting a pendant vinyl silicone polymer with an end capped poly(hydrosiloxane) or poly(tnethylhydrosiloxane) copolymers or a crosslinked MT or MQ resin containing Si—H reactive groups via Pt catalyzed hydrosilylation route. The effective Si—H/Si-alkenyl mole ratio [r] which will be made to react to form a Si—C linkage must satisfy r≤0.3. The final “Gel Rheology” must satisfy the condition

### a) 0.2≤G′≤1000 (Pa);

### b) 0.1p23 G″/G′≤10;

where the term G′ represents the “storage shear modulus” of the final pre-cured gel composition to be used in the thermal interface material formulation measured at T=25° C. under an oscillation frequency of 1 Hz or 6.28 rads by a stress or strain controlled rheometer, and the term G″ represents the “loss shear modulus” of the final pre-cured gel composition to be used in thermal interface material foi ululation measured at T=25° C. under an oscillation frequency of 1 Hz or 6.28 rad/s by a stress or strain-controlled rheometer. G″ and G′ are collectively measured in the respective viscoelastic region.

The following examples are intended to illustrate aspects and embodiments of the present technology. All parts and percentages are by weight and all temperatures are in Celsius unless explicitly stated otherwise. All patents, other publications, and U.S. patent applications referred to in the instant application are incorporated herein by reference in their entireties.

### EXAMPLES

Synthesis of Crossed-linked PDMS Gel (A-1) of Storage Modulus 16.17 Pa at 1 Hz: Vinyl stopped PDMS (500 g, MW ˜17280 g/mol, Vinyl meq ˜0.115) along with Pt catalyst (2 wt. % Karstedt's catalyst, 10 ppm Pt) and inhibitor (Surfynol® 61, 200 ppm) were charged to a double planetary mixer at room temperature and allowed to mix at room temperature for 30 minutes at 20 rpm. To the reaction mixture at 50° C., silicone hydride (55.4 g, MW ˜40802, Hydride meq ˜0.1586) was added and continued the mixing for an additional 1 hour at 20 rpm. While the mixing continues at the same speed at 50° C., the vacuum is applied for 60 minutes to remove the inhibitor to form the gel network. The reaction temperature then increases to 90° C. and is continued till all the hydride gets consumed and a gel is being formed.

Synthesis of Crossed-linked PDMS Gel (A-2) of Storage Modulus 28.4 Pa at 1Hz: Vinyl stopped PDMS (500 g, MW ˜17280 g/mol, Vinyl meq ˜0.115) along with Pt catalyst (2 wt. % Karstedt's catalyst, 10 ppm Pt) and inhibitor (Surfynol® 61, 200 ppm) were charged to a double planetary mixer at room temperature and allowed to mix at room temperature for 30 minutes at 20 rpm. To the reaction mixture at 50° C., silicone hydride (64.5 g, MW ˜40802, Hydride meq —0.1586) was added and continued the mixing for an additional 1 hour at 20 rpm. While the mixing continues at the same speed at 50° C. , the vacuum is applied for 60 minutes to remove the inhibitor to form the gel network. The reaction temperature then increases to 90° C. and is continued till all the hydride gets consumed and a gel is being formed.

Synthesis of Crossed-linked PDMS Gel (A-3) of Storage Modulus 88.5 Pa at 1 Hz: Vinyl stopped PDMS (500 g, MW ˜17280 g/mol, Vinyl meq ˜0.115) along with Pt catalyst (2 wt. % Karstedt's catalyst, 10 ppm Pt) and inhibitor (Surfynol® 61, 200 ppm) were charged to the reactor at room temperature and allowed to mix at room temperature for 30 minutes at low rpm. To the reaction mixture at 50° C., silicone hydride (73.79 g, MW ˜40802, Hydride meq 0.1586) was added and continued the mixing for additional 1 h at moderate rpm. While the mixing continues at the same speed at 50° C., the vacuum is applied for 60 minutes to remove the inhibitor to form the gel network. The reaction temperature then increases at 90° C. and continued till all the hydride gets consumed and a gel is being formed.

Synthesis of Crossed-linked PDMS Gel (A-4) of Viscosity 0.8Pas.: Vinyl stopped PDMS (500 g, MW 8180 g/mol, Vinyl meq 0.18 mmpl/g) along with Pt catalyst (2 wt. % Karstedt's catalyst, 20 ppm Pt) were charged to a double planetary mixer at room temperature and allowed to mix at room temperature for 30 minutes at 20 rpm. To the mixture, silicone hydride (0.22 g, MW 2160 g/mol, Hydride meq 8.8 mmol/g) was added and continued the mixing for an additional 1 hour at 20 rpm. While the mixing continues at the same speed at 50° C., the vacuum is applied for 60 minutes to remove the inhibitor to form the gel network. The reaction temperature then increases to 150 oC and is continued till all the hydride gets consumed and a gel is being formed.

Properties of Gels used in the Formulation

TABLE 1

| | Properties | | |
|---|---|---|---|
| | | Product | |
| | | Storage | |
| Compositions | Product | modulus | Product |
| of the | Viscosity | (G′) | VE factor |
| invention | (PaS) | (Pa at 1 Hz) | (G″/G′) |
| A-1 | 9.1 | 16.17 | 2.7 |
| A-2 | 19.1 | 28.4 | 2.5 |
| A-3 | 43.2 | 88.5 | 1.5 |
| A-4 | 0.8 | 0.9 | 5.1 |

Preparation of Pre-Cured Gel Formulation

Specific amount of the hydrolysable polysiloxane and organopolysiloxane, an alkenyl functionalized and hydrogen functionalized organopolysiloxane were weighed in FlackTek container and mixed for 30 sec at 2000 rpm. To this mixture, the alumina/aluminum nitride with the variable particle size was added step wise and all the materials were mixed together using a Thinky mixer at 2000 rpm for 30 sec at each step. After 30 sec of mixing, the formulation was hand mixed with broad blade spatula for 2 min. This was followed by addition of Boron nitride addition and the mixture is further mixed in Thinky mixer at 2000 rpm for 30 sec. After mixing, the formulation was degassed at room temperature to remove any trapped air within.

Steady shear viscosity and thixotropy were determined using Rheometer (DHR-3) TA Instruments Inc. with Parallel plate geometry (measuring geometry gap 300 μm)

Hardness test. The hardness of the gels was measured using ASTMD2240 Type durometer (Type 00) and ASTM D-217 penetrometer (penetration range: 0-400 Pen ˜40 mm; penetration time: 5 sec).

Bulk thermal conductivity of the thermal gel composition was measured using TP 500S hot disk instrument at 22° C.

The dispensability measurement was carried out using automated dispenser Nordson EFD using 30 cc syringe with 2 mm opening.

The oil bleeds out test (bleed out performance) was performed keeping 0.2 to 0.5 g sample on different substrate for 24 hours at 150° C.

The vertical slippage test (vertical stability performance) was performed by placing 2 gm of formulation between aluminum/alumina Q panel and glass plate of 5 cm×5 cm dimension with spacer of 0.5, 1, 2 mm to form circle. The plates are clamped together with paper clip and placed in vertical position and are subjected to temp cycle or shock (−40 to 150° C.).

Compositions were prepared according to the examples listed in Tables 2 and 3.

(B-1) is a hydrolyzable organopolysiloxane (II-i) represented by a compound of the formula:

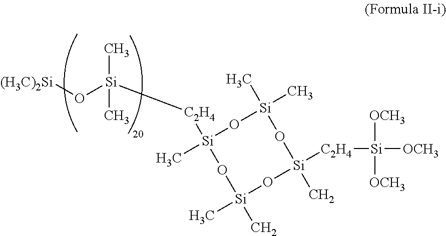

B-2 is a hydrolysable polyorganosiloxane represented by a compound of the formula (II-ii):

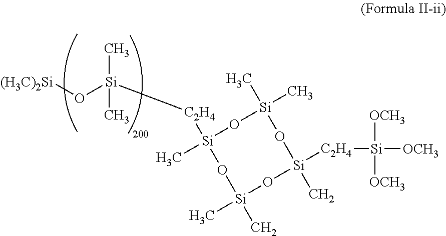

Alumina oxide of 0.2-0.5 micron size (C-1) was purchased from Nippon Light Metal Company Ltd.

Alumina oxide of 2-10 microns size (C-2) was procured from Micron.

Alumina oxide of 4-10 microns size (C-4) was procured from Micron.

Alumina oxide of 75-150 microns size (C-3) was procured from Micron.

Boron nitride (High purity Single crystal) of size 10-120 micron (C-5) was procured from Wonik.

Aluminum nitride of size 70-150 micron (C-6) was procured from Toyo.

Zinc oxide of <0.1 microns size (C-7) was procured from Zochem.

Alumina oxide of 0.4 microns size (C-8) was procured from Sumitomo.

Alumina oxide of 3 microns size (C-9) was procured from Sumitomo.

Aluminum nitride of size 5 micron (C-10) was procured from Toyo.

Aluminum nitride of size 100 micron (C-11) was procured from Toyo.

Aluminum nitride of size 120 micron (C-12) was procured from Toyo.

TABLE 2

| Components (wt %) | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Crosslinked polysiloxane | A-1 | | | 1.9 | | 1.9 | | | |
| | A-2 | 3.5 | 1.9 | | 1.9 | | 5 | | |
| | A-3 | | | | | | | | |
| | A-6 | | | | | | | 2.2 | 2.2 |
| Hydrolyzable | B-1 | 4 | 4.6 | 4.1 | 4.1 | 4.1 | | 3 | 3 |
| organopolysiloxane | B-2 | | | | | | 10 | | |
| Conductivity enhancing agent | C-1 | 31.5 | 28.1 | 25.1 | 21.6 | 21.6 | 28 | | |
| | C-2 | 22.5 | 20.3 | 10.1 | 13.8 | 13.8 | 28 | | |
| | C-3 | 34.5 | 42.6 | 42.6 | 47.6 | | | | |
| | C-4 | | | 10.1 | 5 | 5 | | | |
| | C-5 | 3.5 | 2 | 5.5 | 5.5 | 5.5 | 29 | | |
| | C-6 | | | | | 47.6 | | | |
| | C-7 | | | | | | | 4 | 4 |
| | C-8 | | | | | | | 17.8 | 17.8 |
| | C-9 | | | | | | | 3.2 | 3.2 |
| | C-10 | | | | | | | 24.4 | 24.4 |
| | C-11 | | | | | | | 45.4 | |
| | C-12 | | | | | | | | 45.4 |
| Additive | F-1 | 0.5 | 0.5 | 0.5 | 0.5 | 0.5 | | | |
| | Total | 100 | 100 | 99.9 | 100 | 100 | 100 | 100 | 100 |
| Dispensability (g/min) | | 42 | 48 | 18 | 9 | 12 | 25 | 24 | 13 |
| Thermal conductivity (W/mK) | | 4.6 | 5 | 6.6 | 7.1 | 10.1 | 4.6 | 10 | 13.4 |

TABLE 3
Comparative Examples (CE)

| Components (wt %) | | CE-1 | CE-2 | CE-3 | CE-4 | CE-5 | CE-6 | CE-7 | CE-8 | CE-9 | CE-10 | CE-11 | CE-12 |
|---|---|---|---|---|---|---|---|---|---|---|---|---|---|
| Crosslinked polysiloxane | A-1 | | | | | | | | | | 2 | | |
| | A-2 | | 2 | 2.2 | 3.25 | 2 | 2 | 2 | 3.5 | 3.25 | | | 6.5 |
| | A-3 | 2.5 | | | | | | | | | | | |
| Hydrolyzable | B-1 | | | | | 0.9 | 4.5 | 4 | 3.5 | 3.25 | 1.9 | | |
| organopolysiloxane | B-2 | 4.5 | 4.5 | 4.5 | 3.25 | 3.6 | | | | | 3.15 | | |
| Conductivity enhancing | C-1 | 26.5 | 26.5 | 29.8 | 29.9 | 26.5 | 26.5 | 18.7 | 26.3 | 29.9 | 26.5 | 18.6 | 18.6 |
| agent | C-2 | 26.5 | 21.5 | 26.9 | 26.9 | 21.5 | 21.5 | 18.7 | 21.4 | 26.9 | 21.5 | 18.6 | 18.6 |
| | C-3 | 39.5 | 45 | 36.1 | 36.2 | 45 | 45 | 56.1 | 44.8 | 36.2 | 45 | 55.8 | 55.8 |
| | C-4 | | | | | | | | | | | | |
| | C-5 | | | | | | | | | | | | |
| | C-6 | | | | | | | | | | | | |
| Additive | D-1 | | | | | | | | | | | 6.5 | |
| | F-1 | 0.5 | 0.5 | 0.5 | 0.5 | 0.5 | 0.5 | 0.5 | 0.5 | 0.5 | 0.5 | 0.5 | 0.5 |
| | Total | 100 | 100 | 100 | 100 | 100 | 100 | 100 | 100 | 100 | 100 | 100 | 100 |
| Dispensability (g/min) | | 23 | 18 | 16 | 26 | 20 | 63 | 47 | 45 | 26 | 21 | Powdery | Powdery |
| Thermal conductivity | | 3.7 | 4.1 | 3.7 | 4 | 4.3 | 4.5 | 5.1 | 4 | 4.2 | 4.2 | — | — |
| (W/mK) | | | | | | | | | | | | | |

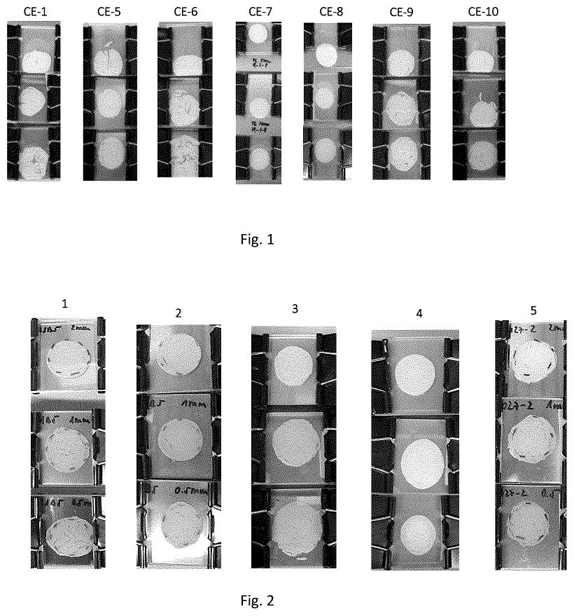

FIG. 1 and FIG. 2 illustrates an embodiment of the composition. Vertical stability performance was measured under thermal shock cycles after 500 h (given weight of samples sandwiched between aluminum and glass panels with gap of 0.5 mm, 1 mm and 2 mm gap, bottom to top) under thermal shock (−40° C. to 150° C.). The numbers in the figure represent pictures for the corresponding numbered example in the above tables.

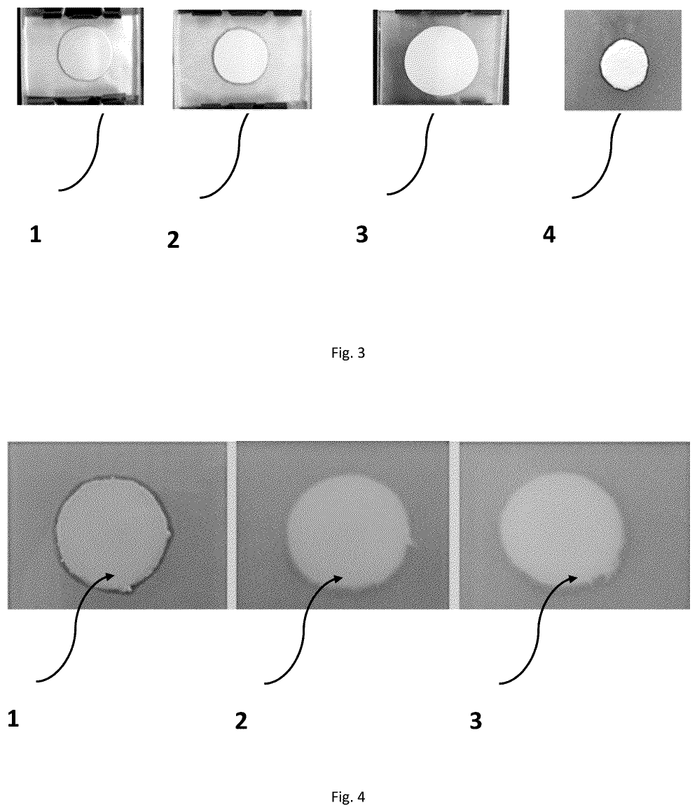

FIG. 3 illustrates another embodiment of the composition. Bleed out performance was measured on different substrates for example 2, (1) on A4 paper covered with glass (spacer 1.5 mm;25° C. for 24 hours) at a bleed distance of 1 mm; (2) on butter paper covered with glass (spacer 1.5 mm; 25° C. for 24 hours) at a bleed distance of 1.5 mm; (3) on aluminum plate covered with glass (spacer 1.5 mm; 150° C. for 24 hours) at a bleed distance of 0 mm and (4) on foster glass plate, 150° C. for 24 hours at a bleed distance of 1 mm.

FIG. 4 illustrates another embodiment of the composition. Bleed out performance was measured on smoke glass at different temperature for example 4: (1) room temperature; (2) at 70° C. and (3) at 175° C.

As illustrated in Table 2, compositions comprising crosslinked siloxane and hydrolyzable polysiloxane (B-1) provide enhanced dispensability (up to 48 g/min) and thermal conductivity (4-10 W/mK) as compared to that of (Dispensibility up to 23 g/min and thermal conductivity in the range of 3.7 to 4.1 W/mK) compositions conventionally known (Table 3). Further, the compositions enable improved reliability performance. Furthermore, by providing a simple yet effective solution to the conventional challenge of simultaneously achieving a combination of high processability, dispensibility, and thermal conductivity, the composition of the present invention addresses a longstanding need.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an thermal gel compositions and applications of such compounds. Modifications may occur to those skilled in the art and to those who may make and use the invention. The disclosed embodiments are merely for illustrative purposes and not intended to limit the scope of the invention or the subject matter set forth in the claims.

1. A one-component thermal-gel composition comprising:
(A) a cross linkable organopolysiloxane prepared by reaction of:
(i) an alkenyl-functionalized diorganopolysiloxane of formula (Ia)
(i) an alkenyl-functionalized diorganopolysiloxane of formula (Ia)
M¹ₐM²_{b}D¹_{c}D²_{d}T¹ₑT²_{f}Q_{g} (Ia)
wherein
M¹=R¹R²R³SiO_{1/2}
M²=R⁴R⁵R⁶SiO_{1/2}
D¹=R⁷R⁸SiO_{2/2}
D²=R⁹R¹⁰SiO_{2/2}
T¹=R¹¹SiO_{3/2}
T²=R¹²SiO_{3/2}
Q=SiO_{4/2}
where R², R³, R⁴, R⁵, R⁶, R⁸, R⁹, R¹⁰, R¹² are each independently selected from an aliphatic, aromatic, or fluoro monovalent hydrocarbon having from 1 to 60 carbon atoms or alkoxy groups;
R¹, R⁷, R¹¹ are monovalent radical containing at least one terminal olefin bond; and
the subscripts a, b, c, d, e, f, and g are zero or a positive integer subject to the following limitations: 1≤a+b+c+d+e+f+g≤6000, and a+c+e≥1;
with
M¹_{a′}M²_{b′}D¹_{c′}D²_{d′}T¹_{e′}T²_{f′}Q_{g′} (Ib)
wherein:
M¹=R¹³R¹⁴R¹⁵SiO_{1/2}
M²=R¹⁶R¹⁷R¹⁸SiO_{1/2}
D¹=R¹⁹R²⁰SiO_{2/2}
D²=R²¹R²²SiO_{2/2}
T¹=R²³SiO_{3/2}
T²=R²⁴SiO_{3/2}
Q=SiO_{4/2}
where R¹⁴, R¹⁵, R¹⁶, R¹⁷, R¹⁸, R²⁰, R²¹, R²², R²⁴ are aliphatic, aromatic or fluoro monovalent hydrocarbon having from 1 to 60 carbon atoms;
R¹³, R¹⁹, R²³ are hydrogen;
the subscript a′, b′, c′, d′, e′, f, and g′ are zero or a positive integer subject to the following limitations: 1<a′+b′±c′+d′+e′+f+g′≤6000, and a′+c′+e′ ≥1;
with the proviso that when a′+c′+e′=1 then a+c+e>1 and when a+c+e=1 then a′+c′+e′>1;
(B) a hydrolyzable organopolysiloxane selected from a compound of formula (II), formula (III), or a combination therefore, where formula (II) is of the formula: 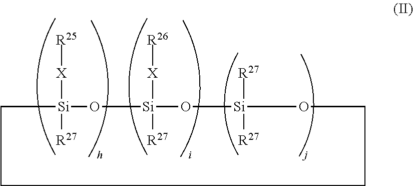
wherein
R²⁵ is a group having an alkoxysilyl group having 1 to 4 carbon atoms;
R²⁶ is a linear organosiloxy group (III): 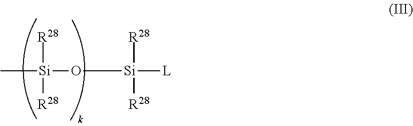
wherein each R²⁸ is independently a monovalent hydrocarbon group having 1 to 12 carbon atoms; L is selected from a monovalent hydrocarbon group having 1 to 6 carbon atoms, and an alkoxysilyl group having 1 to 4 carbon atoms; and k is an integer from 10 to 500;
each X is independently a divalent hydrocarbon group having 2 to 10 carbon atoms;
each of h and i is independently an integer of 1 or more;
j is an integer of 0 or more;
h+i+j is an integer of 4 or more; and
each R²⁷ is independently selected from hydrogen and a monovalent hydrocarbon group having 1 to 6 carbon atoms; and
formula (IV) is: 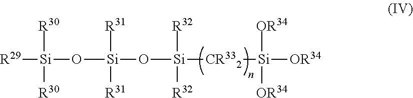
where wherein, R²⁹ represents an unsubstituted or substituted alkyl group, alkenyl group or aryl group, each R³⁰ represents, independently, an unsubstituted or substituted alkyl group, alkenyl group or aryl group, R³¹ and R³² each represent identical or different unsubstituted or substituted monovalent hydrocarbon groups, each R³³ represents, independently, a hydrogen atom, or an unsubstituted or substituted monovalent hydrocarbon group, each R³⁴ represents, independently, an unsubstituted or substituted alkyl group, alkoxyalkyl group, alkenyl group or acyl group, m represents an integer from 0 to 4, and n represents an integer from 2 to 20;
(C) a thermal conductivity enhancing agent;
(D) optionally an organopolysiloxane having an average of at least one silicone bonded alkenyl group per molecule;
(E) optionally an adhesion promoter;
(F) optionally an antioxidant; and
(G) optionally a pigment.

2. The thermal-gel composition of claim 1, wherein the hydrolyzable organopolysiloxane (B) is selected from a compound of formula (II).

3. The thermal-gel composition of claim 2, wherein k is 10 to 50.

4. The thermal-gel composition of claim 2, wherein the hydrolyzable organopolysiloxane (B) comprises two or more hydrolyzable organopolysiloxane compunds of the formula (II).

5. The thermal-gel composition of claim 4, wherein the hydrolyzable organopolysiloxane (B) comprises a first hydrolyzable organopolysiloxane of the formula (II) where k is 10 to 50, and a second hydrolyzable organopolysiloxane of the formula (II) where k is 100 to 500.

6. The thermal-gel composition of claim 1, wherein the cross-linkable organopolysiloxane (A) is present in an amount of from about 0.2 wt. % to about 10 wt. % based on the total weight of the composition.

7. The thermal-gel composition of any of claims 5, wherein the first hydrolyzable orgaonopolysiloxane is present in an amount of from about 0.2 wt. % to about 10 wt. % based on the total weight of the composition, and the second hydrolyzable organopolysiloxane is present in an amount of from about 0.2 wt. % to about 10 wt. % based on the total weight of the composition.

8. The thermal-gel composition of claim 1, wherein the cross-linkable organopolysiloxane (A) is present in an amount of from about 0.2 wt. % to about 10 wt. % based on the total weight of the composition.

9. The thermal-gel composition of claim 1, wherein the thermal conductivity enhancing agent is selected from a metal oxide, a metal nitride, a metal carbide, a metal, a metal alloy, a carbon based filler, or a combination of two or more thereof.

10. The thermal gel-composition of claim 9, wherein the thermal conductivity enhancing agent is selected from diamond, graphite, graphene, carbon nanotubes, boron nitride, aluminum nitride, silicon nitride, titanium nitride, zirconium nitride, aluminum oxide, zinc oxide, zirconium oxide, cerium oxide, magnesium oxide, or a mixture of two or more thereof.

11. The thermal-gel composition of claim 1, wherein the thermal conductivity enhancing agent is present in an amount of from about 80 wt. % to about 97 wt. % based on the total weight of the composition.

12. The thermal-gel composition of claim 9, wherein the thermal conductivity enhancing agent is selected from a first aluminum oxide of a first particle size, a second aluminum oxide of a second particle size, and a third aluminum oxide of a third particle size.

13. The thermal-gel composition of claim 12, wherein the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

14. The thermal-gel composition of claim 12 wherein the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

15. The thermal-gel composition of claim 9, wherein the thermal conductivity enhancing agent comprises aluminum oxide and boron nitride.

16. The thermal-gel composition of claim 15, wherein the aluminum oxide is present in an amount of from about 50 wt. % to about 95 wt. % based on the total weight of the composition, and the boron nitride is present in an amount of from about 2 wt. % to about 30 wt. % based on the total weight of the composition.

17. The thermal-gel composition of claim 15 or 16, wherein the aluminum oxide comprises a first aluminum oxide of a first particle size, a second aluminum oxide of a second particle size, and a third aluminum oxide of a third particle size.

18. The thermal-gel composition of claim 17, wherein the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

19. The thermal-gel composition of claim 17wherein the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

20. The thermal-gel composition of claim 9, wherein the thermal conductivity enhancing agent comprises aluminum oxide, boron nitride, and aluminum nitride.

21. The thermal-gel composition of claim 15, wherein the aluminum oxide is present in an amount of from about 50 wt. % to about 95 wt. % based on the total weight of the composition, the boron nitride is present in an amount of from about 2 wt. % to about 30 wt. % based on the total weight of the composition, and the aluminum nitride is present in an amount of from about 30 wt. % to about 95 wt. % based on the total weight of the composition.

22. The thermal-gel composition of claim 20, wherein the aluminum oxide comprises a first aluminum oxide of a first particle size, a second aluminum oxide of a second particle size, and a third aluminum oxide of a third particle size.

23. The thermal-gel composition of claim 22, wherein the first aluminum oxide has an average particle size from about 0.01 to about 0.5 μm; the second aluminum oxide has an average particle size of about 1 μm to about 25 μm; and optionally a third aluminum oxide having an average particle size of about 40 μm to about 100 μm.

24. The thermal-gel composition of claim 22 wherein the first aluminum oxide is present in an amount of from about 10 wt. % to about 40 wt. % based on the total weight of the composition; the second aluminum oxide is present in an amount of from about 5 wt. % to about 30 wt. % based on the total weight of the composition; and the third aluminum oxide is present in an amount of from about 30 wt. % to about 70 wt. % based on the total weight of the composition.

25. The thermal-gel composition of claim 9, wherein the thermal conductivity enhancing agent is comprises zinc oxide, aluminum oxide, and aluminum nitride.

26. The thermal-gel composition of claim 25, wherein the aluminum oxide comprises a first aluminum oxide of a first average particle size and a second aluminum oxide of a second average particle size, and the aluminum nitride comprises a first aluminum nitride of a first average particle size and a second aluminum nitride of a second average particle size.

27. The thermal-gel composition of claim 26, wherein the first aluminum oxide has an average particle size from about 0.01 to about 0.5 μm; the second aluminum oxide has an average particle size of about 1 μm to about 25 μm; wherein the first aluminum nitride has an average particle size from about 1 μm to about 25 μm; and the second aluminum nitride has an average particle size of about 40 μm to about 150 μm.

28. A device comprising a first substrate, a second substrate, and an interface material bridging an interface between the first and second substrate, wherein the thermal interface material comprises the one-component thermal-gel composition of claim 1.

29. A heat dissipating material comprising the thermal gel composition of claim 1.

30. A method of dissipating heat from a substrate, the method comprising contacting the substrate with the thermal gel composition of claim 1.

31. A method of preparing a treated substrate comprising applying the thermal gel composition of claim 1.
